(19) United States
(12) Patent Application Publication
(10) Pub. No.: US 2003/0147238 A1
(43) Pub. Date: Aug. 7, 2003

(54) Liquid driven generator for low power electrical components

(76) Inventors: David G. Allen, Toronto (CA); Greg Porter, Schomberg (CA); Ron Bouffard, Calgary (CA)

Correspondence Address: Tyco Electronics Corporation, 307 Constitution Drive, MS R20/2B, Menlo Park, CA, 94025-1110, US

(21) Appl. No.: 10/072,188

(22) Filed: Feb. 7, 2002

(51) Int. Cl. B60Q 1/00

(52) U.S. Cl. 362/192

(57) ABSTRACT

A hydroelectric generator is provided for driving electrical components. The generator includes a housing configured to be connected to a water supply and includes an inlet port and a discharge port arranged at opposite ends thereof. The housing includes a linear passageway extending along a straight path entirely through the housing that is configured to convey water from the inlet port to the discharge port. The hydroelectric generator also includes a power generator mounted in the passageway and configured to convert energy from water flowing through the passageway into electric power. The generator includes magnets and a coil centered within the passageway with at least one of the coil and magnets being adapted to be rotated relative to the housing in response to flowing water. The hydroelectric generator includes an electric output from the power generator delivering electrical power to an electrical component connected to the power generator.

### BACKGROUND OF THE INVENTION

Certain embodiments of the present invention generally relate to a liquid driven generator for low power electrical components. More particularly, certain embodiments of the present invention relate to a water powered illuminescent device that converts flowing water into lighting.

Liquid powered generators have been proposed in the past for various applications. One application is for swimming pools that include lighting devices located in the walls of the pools. Generally the lights are located beneath the surface of the water. The purpose of a pool lighting device is to illuminate the water and thus make the pool safer and extend the hours the pool may be used whether the pool is located outside or inside. The lights have been powered in one of two ways, namely by a remote source of electrical power or by the flow of water that is circulated between the pool and a water filtering system. The latter method has become increasingly popular because of the difficulty and expense of wiring pool lights to a remote electrical power source.

Conventional liquid powered lighting devices are described in U.S. Pat. No. 3,845,291 issued to Portyrata and U.S. Pat. No. 4,616,298 issued to Bolson, both of which include a housing, an impeller, a generator, and a light source. The impeller and generator are located within a passageway, while the light source is retained within the housing at the passageway outlet. The water flows from the passageway into the pool, causing the impeller to rotate. The impeller is connected to a shaft that drives the generator.

The typical water powered light device suffers from several flaws. First, the device utilizes incandescent light bulbs which require a great deal of power and therefore demand a strong water flow and a large generator to convert the water flow into electrical power. At times, the water flow may not be strong enough for the generator to supply the requisite power to the light bulb. Additionally, the large size of the generator significantly obstructs and diverts the water flow within the passageway. Likewise, an incandescent light bulb is large and takes up a significant amount of space within the housing. The water thus must be directed along a curved path around the light bulb to escape the housing. Diverting the water flow around the large light bulb and generator causes turbulence in the water flow which reduces the flow rate of the water through the housing and which reduces the efficiency with which the water transfers power to the impeller. For example, turbulence may cause the impeller to cavitate, where water flows past the impeller without inducing a driving force onto the impeller blades. Hence, less power is generated when the water contacts the impeller.

The housing of the typical water powered light device also restricts the flow of water. The interior passageway of the housing is generally shaped to direct the flowing water around the impeller, the generator, and the light source and out of the housing. In conventional designs, the passageway itself changes direction several times, and thus the water flow is diverted in several different directions, sometimes by as much as ninety degrees, before being discharged. Drastic changes in direction along the passageway length cause the water flow to slow down and therefore generate less power. Besides being non-linear along its length, the passageway may also not be uniform in diameter. In other words, as the water flows through the passageway, the passageway may decrease in diameter, thus restricting the water and reducing the velocity of the water flow and the amount of power created by the generator. Another problem associated with a meandering or curved passageway, or with a changing passageway diameter, is that small pieces of debris may easily be caught in, and clog up, the passageway thus reducing or even blocking the flow of water.

Thus, a need exists for a liquid driven generator for low power electrical components.

### BRIEF SUMMARY OF THE INVENTION

Certain embodiments provide a hydroelectric generator that drives low powered electrical components. The hydroelectric generator includes a housing that is adapted to be connected to a water supply. The housing includes an inlet port and a discharge port that are located opposite each other across the length of the housing. The housing also includes a linear passageway that extends from the inlet port to the discharge port along a straight path and that delivers water from the inlet port to the discharge port. The hydroelectric generator also includes a power generator that is positioned in the passageway and that converts energy from the water flowing through the housing into electric power. The generator includes magnets and a coil centered about an axis of the linear passageway. Either the coil or the magnet is adapted to rotate relative to the housing about the axis in response to the water flowing through the housing. An electrical conduit conveys electrical power from the power generator to a low power electrical component that is connected to the power generator.

Certain embodiments provide a self-powered light that includes a housing that may be connected to a liquid supply. The housing includes an inlet port and a discharge port arranged at opposite ends of the housing and includes a passageway interconnecting the inlet and discharge ports. The housing is aligned along a longitudinal axis. The self-powered light further includes a power generator that is located in the passageway in order to convert liquid flowing through the passageway into electrical power. A plurality of light emitting diodes are aligned in a ring concentrically about either the entry port or exit port.

Certain embodiments include a liquid powered illuminescent device. The illuminescent device includes a housing that may be connected to a liquid supply. The housing has an inlet port, a discharge port, and a linear passageway. The inlet port and discharge port are arranged opposite each other across the length of the passageway. The passageway may deliver liquid from the inlet port to the discharge port. The illuminescent device also includes a power generator that is situated in the passageway and that may convert energy from liquid passing through the passageway into electric power. The illuminescent device further includes a light source that is located on the housing and powered by the power generator.

### BRIEF DESCRIPTION OF SEVERAL VIEWS OF THE DRAWINGS

FIG. 1 illustrates a sectional isometric view of a liquid powered illuminescent device formed in accordance with an embodiment of the present invention.

FIG. 2 illustrates the housing and light ring of FIG. 1 with the generator assembly removed.

FIG. 3 illustrates a cutaway side view of the illuminescent device of FIG. 1 taken along section 3-3 in FIG. 1.

FIG. 4 illustrates a cutaway side view of a generator assembly according to an alternative embodiment of the present invention.

FIG. 5 illustrates an end view of the generator assembly of FIG. 4.

FIG. 6 illustrates a cutaway end view of the generator assembly of FIG. 4.

FIG. 7 illustrates an exploded side view of a liquid powered illuminescent device according to an alternative embodiment of the present invention.

FIG. 8 illustrates an assembled side view of the illuminescent device of FIG. 7.

FIG. 9 illustrates an end view of the liquid powered illuminescent device of FIGS. 7 and 8.

The foregoing summary, as well as the following detailed description of certain embodiments of the present invention, will be better understood when read in conjunction with the appended drawings. It should be understood, however, that the present invention is not limited to the arrangements and instrumentality shown in the attached drawings.

### DETAILED DESCRIPTION OF THE INVENTION

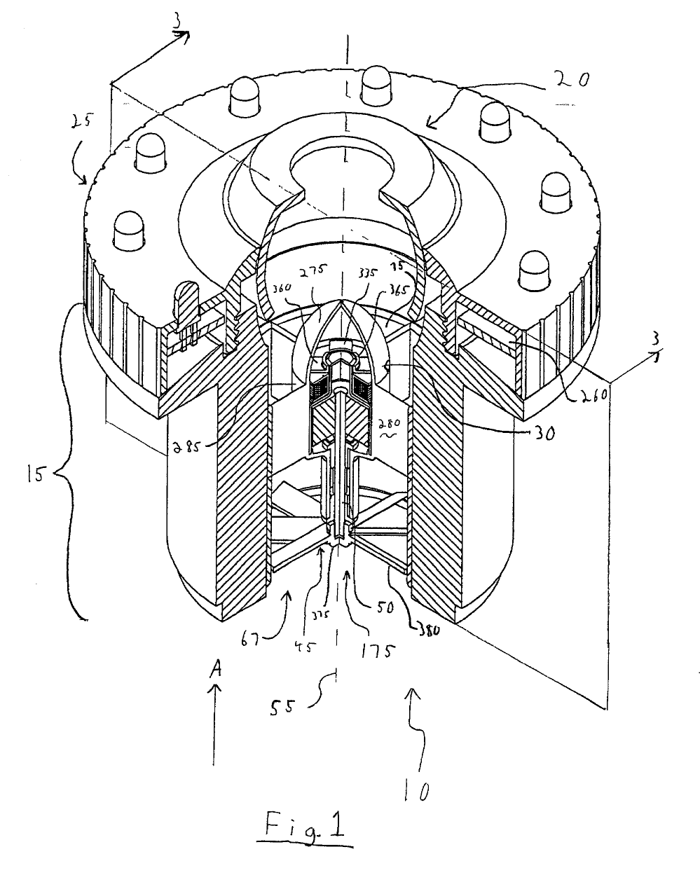

FIG. 1 illustrates a sectional isometric view of a liquid powered illuminescent device 10 formed in accordance with an embodiment of the present invention. The illuminescent device 10 includes a housing 15, a nozzle 20, a light ring 25, and a generator assembly 30. The nozzle 20 and housing 15 form a linear passageway 175 centered about a longitudinal axis 55 that maintains generally a constant diameter throughout an entire length of the passageway 175 to reduce obstruction and diversion. The generator assembly 30 includes a round impeller 45 mounted on a shaft 50. The generator assembly 30 is located within the passageway 175. The nozzle 20 is mounted partially between the light ring 25 and the housing 15, and the light ring 25 is detachably screwed into the housing 15. The illuminescent device 10 may be positioned within a fluid flow path, such as for example, a water pipe (not shown) leading into a swimming pool (not shown) by screwing or press fitting the housing 15 into the pipe with the nozzle 20 facing the direction in which the fluid is discharged.

In operation, fluid flows in the direction of arrow A from the pipe into an entry port 67 of the housing 15 past the impeller 45 and the generator assembly 30 and out through the nozzle 20. Alternatively, the fluid may flow in the opposite direction of arrow A from the nozzle 20 through the housing 15. As the liquid passes the impeller 45, the liquid forces the impeller 45 to rotate. As the impeller 45 rotates, the generator assembly 30 converts the motion of the rotating shaft 50 into electricity which is then conducted from the generator assembly 30 to the light ring 25.

Optionally, the illuminescent device 10 may be used in many applications, such as in fountains, shower nozzles, hot tubs or any other application that utilizes flowing liquid. Also, other electrical devices may be substituted for, or used in tandem with, the light source. For example, the generator assembly 30 may be used to power a timer for sprinklers, a flow meter for pools, or a soap dispenser for a carwash. Similarly, the generator assembly 30 may be used to power a flow measurement device with different lights being lit for different flow rates passing through the housing 15. Optionally, the generator assembly 30 may be powered by different kinds of non-caustic, viscous fluids such as milk in a food processing plant, and the like.

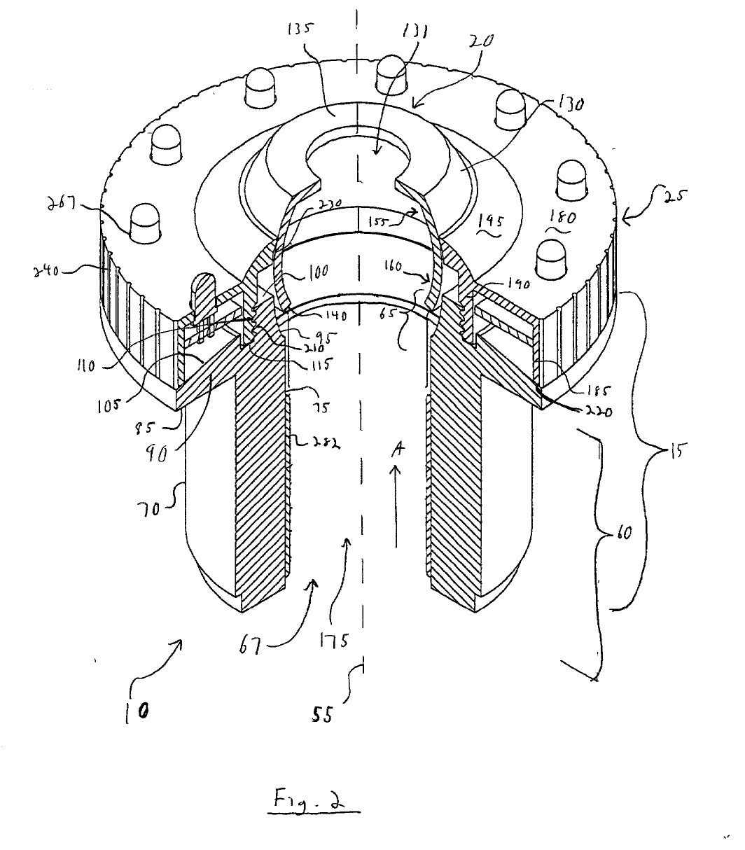

FIG. 2 illustrates the housing 15 and light ring 25 of FIG. 1 with the generator assembly 30 removed. The housing 15 is cylindrically shaped and aligned along a longitudinal axis 55. The housing 15 includes a cylindrical neck 60 and a ring shaped collar 65. The neck 60 includes an inlet port 67, a cylindrical outside wall 70 and a cylindrical inside wall 75. The inside wall 75 defines a uniform inner diameter that extends throughout the housing 15 so that the fluid that passes through the housing 15 flows in the same unaltered linear direction from the inlet port 67 to the nozzle 20. The outside wall 70 may be smooth so that the neck 60 may be press fit into a pipe. Alternatively, the outside wall 70 may include threads that are screwed into the pipe.

The collar 65 includes a concentric portion 90 that extends radially outward from the passageway 175. The concentric portion 90 includes an upper sloped surface 105 that slopes downward as it extends radially outward from the passageway 175. The concentric portion 90 also includes a bottom surface 85 that joins a pipe or other structure to which the illuminescent device 10 is mounted. The collar 65 includes a circular nose cone 100 that is arranged concentrically around the longitudinal axis 55. The nose cone 100 includes an interior wall 95 that curves radially outward and upward from the inside wall 75. The nose cone 100 also includes a threaded outer wall 110. The collar 65 includes a circular, concentric retention cavity 115 located inside of the sloped surface 105. The threaded wall 110 extends along the retention cavity 115. The collar 65 is formed integrally with the neck 60 and extends circumferentially outward from the neck 60 so that the neck 60 has a first outer diameter and the collar 65 has a larger second outer diameter. The collar 65 engages the mounted nozzle 20 and is fastened to the light ring 25 along the threaded wall 110.

The nozzle 20 is aligned along the longitudinal axis 55 and includes a barrel-shaped convex wall 130 and a ring-like flat top surface 135. The convex wall 130 is integrally formed with, and extends downward away from, the top surface 135. The convex wall 130 includes a bottom rim 140 located opposite the top surface 135. The convex wall 130 also includes a maximum outer diameter generally midway between the bottom rim 140 and the top surface 135. The nozzle 20 is mounted between the collar 65 and the light ring 25 so that an outer surface of a lower portion 160 slidably engages the interior wall 95 of the collar 65 and the light ring 25, while an upper portion 155 and the top surface 135 extend beyond and away from the light ring 25. Liquid flows into the nozzle 20 from the housing 15 and out of an opening 131 in the nozzle 20 in the direction of arrow A. The nozzle 20 may be pivotally and/or rotatably adjusted to direct the outflow of liquid in various directions.

The cylindrical light ring 25 is centered about the longitudinal axis 55 and includes a top wall 180 joined with an exterior wall 185 and an interior wall 190. The interior wall 190 is joined at one end with a curved, ring-shaped rim 195. The exterior wall 185 and interior wall 190 are concentric with each other and are both formed integrally with, and extend perpendicularly downward from, the top wall 180. The light ring 25 has an outer diameter measured around the exterior wall 185 that is generally equal to the outer diameter of the collar 65. The interior wall 190 includes a threaded interior side 210 that joins the threaded wall 110 of the collar 65. The exterior wall 185 includes a bottom side 220 that is sloped to correspond to the sloped surface 105. The rim 195 includes a concave interior surface 230 that corresponds to the barrel-curved convex exterior surface of the nozzle 20. The rim 195 and interior wall 95 cooperate to define a spherical chamber in which the nozzle 20 resides free to rotate and pivot. The exterior wall 185 includes stem-like grip scallops 240 that protrude out from the exterior wall 185 and extend in a direction parallel to the longitudinal axis 55. The grip scallops 240 enable a person to grip the light ring 25 when screwing or pushing the light ring 25 onto the housing 15 and when screwing or pushing the illuminescent device 10 into a pipe or other orifice structure.

The light ring 25 is affixed to the collar 65 by positioning the nozzle 20 on top of the collar 65 with the lower portion 160 resting on the interior wall 95 of the collar 65, and aligning the interior wall 190 of the light ring 25 within the retention cavity 115. The light ring 25 is then rotated so that the threaded section 210 of the interior wall 190 rotationally engages the threaded wall 110 of the collar 65.

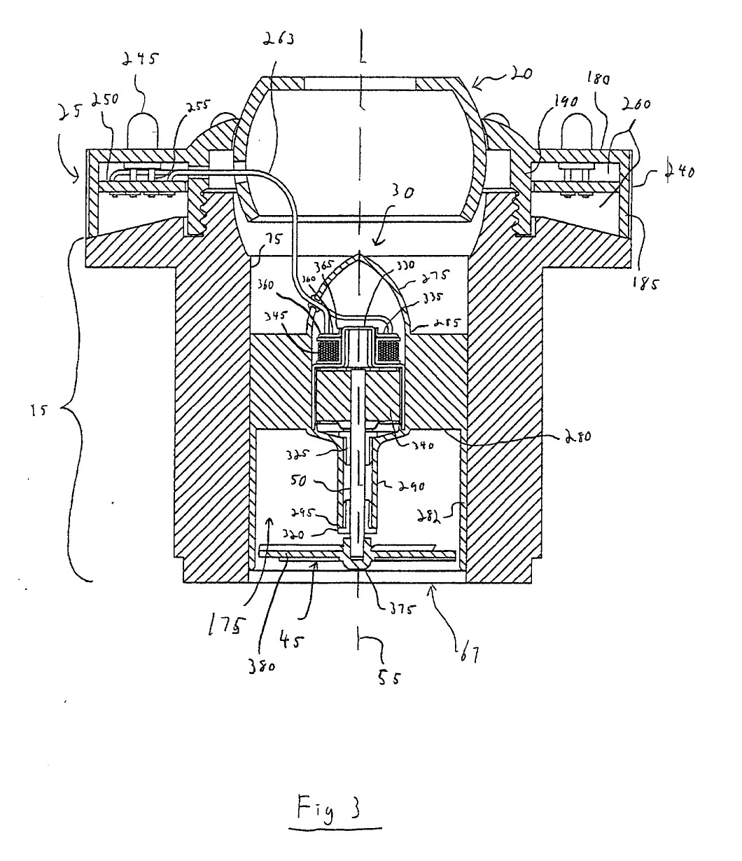

FIG. 3 illustrates a cutaway side view of the illuminescent device 10 taken along section 3-3 of FIG. 1. The light ring 25 includes tube-shaped light emitting diodes 245 and a ring-shaped printed circuit board 250 located concentric about the housing 15. The light emitting diodes 245 are connected to the printed circuit board 250 by conductive stems 255 and are spaced evenly around the printed circuit board 250. The light emitting diodes (LEDs) 245 demand very low power. The LEDs 245 and printed circuit board 250 are located around the perimeter of the nozzle 20 and passageway 175. The printed circuit board 250 is held within a cavity 260 defined between interior wall 190 and exterior wall 185. The printed circuit board 250, conductive stems 255, and light emitting diodes 245 are retained within the light ring 25 between the interior wall 190 and exterior wall 185, such as by an epoxy that fills and hermetically seals cavity 260. The top wall 180 includes apertures 267 (FIG. 2) aligned so as to correspond to, and accept therethrough, the light emitting diodes 245 that extend from the printed circuit board 250 and above the top wall 180. The printed circuit board 250 and light emitting diodes 245, are connected by a wire 263 to the generator assembly 30.

Optionally, electro luminescent films, and other low power light devices may be substituted for the light emitting diodes 245. Also, the light emitting diodes 245 or other light devices may be arranged in any number of different positions and patterns. For example, the light emitting diodes 245 may be aligned circumferentially around the exterior wall 185 between or in place of the grip scallops 240, or the light emitting diodes 245 may extend from the top wall 180 or exterior wall 185 of the light ring 25 at different angles. Optionally, the light “ring” 25 and/or the housing 15 may be square, triangular, octagonal, or any number of other shapes.

The generator assembly 30 is aligned along the longitudinal axis 55 and positioned in the center of the passageway 175 so as to limit interruption of the liquid flow through the passageway 175. The generator assembly 30 includes a bullet-shaped nose cone 275 that joins one end of a cylindrical wall 285 (better shown in FIG. 1). An opposite end of the cylindrical wall 285 joins a funnel-shaped bottom section 290. The generator assembly 30 includes fins 280 that extend outward from the wall 285 at evenly spaced intervals about the perimeter of the generator assembly 30. The fins 280 hold the generator assembly 30 within a hollow tubular sleeve 282. The passageway 175 extends through the sleeve 282. The fins 280, wall 285, and nose cone 275 are shaped and positioned to limit the interference with, and turbulence within, fluid flow through the passageway 175. The sleeve 282 is secured within the inside wall 75 of the housing 15. The nose cone 275, fins 280, and bottom section 290 are all integrally formed with the wall 285. The nose cone 275 extends from the wall 285 toward the nozzle 20. The bottom section 290 is sloped inward from the bottom edge of the wall 285 toward the shaft 50, and is contoured to encircle the shaft 50. The bottom section 290 encases the shaft 50 and directs fluid flowing through the passageway 175 along the generator assembly 30 as the diameter of the generator assembly 30 expands from a small diameter tail end 295 of the bottom section 290 to a large diameter about the wall 285 with minimal turbulence.

The generator assembly 30 includes bearings 320 and 325, a cap 330, tabs 335, magnets 340, and a coil 345. The bearings 320 and 325 rotatably support the shaft 50. The bearing 320 is located between the shaft 50 and the inner surface of the tail end 295. The bearing 320 seals the tail end 295 so that fluid cannot enter the generator assembly 30. The bearing 325 is located between the shaft 50 and the bottom section 290 near the magnets 340. The shaft 50 is aligned along the longitudinal axis 55 and has a first end that is fixed to the impeller 45 proximate to the inlet port 67 and a second end attached to the magnets 340. The cylindrical cap 330 is located at the second end 355 of the shaft 50 and the coil 345 is wrapped around the cap 330. The cap 330 and coil 345 do not rotate with the shaft 50 in the embodiment of FIG. 3. Alternatively, the coil 345 and cap 330 may be attached to the second end of the shaft 50 so that the coil 345 and cap 330 would rotate with the shaft 50.

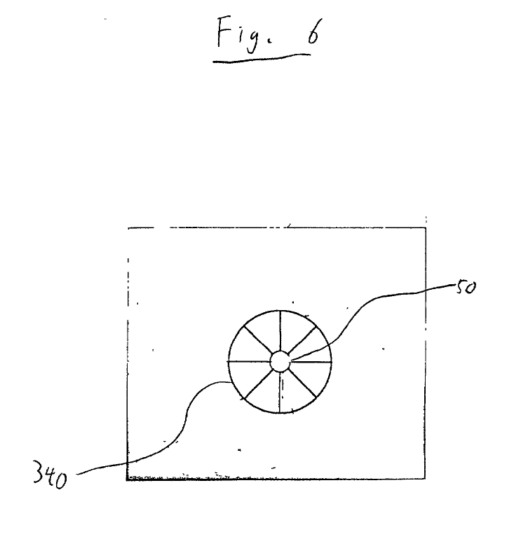

As illustrated in FIG. 6, the magnets 340 may be pie or wedge shaped and combined to surround the shaft 50. The magnets 340 may be aligned around the shaft 50 in groups of two, four, eight, or some other number.

As shown in FIGS. 1 and 3, the tabs 335 may be L-shaped to include first and second legs 360 and 365, and are connected to the cap 330. The first legs 360 are located along the top of the coil 345, while the second legs 365 extend upward perpendicular to the first legs 360. Thus, the tabs 335 facilitate electromagnetic coupling of the coil 345 and magnets 340 so that the magnetic field created by the rotating magnets 340 is better focused about the coil 345.

As shown in FIGS. 1 and 3, the impeller 45 is centered about the longitudinal axis 55 and is connected to the end of the shaft 50 proximate the inlet port 67. The impeller 45 includes a hub 375 securely connected to the end of the shaft 50 so that the hub 375 rotates with the shaft 50. Blades 380 are formed integral with the hub 375 and extend outward from the hub 375 toward the inside wall 75. The blades 380 are oriented at an acute angle to a reference plane that is perpendicular to the longitudinal axis 55. The blades 380 are sloped so that as liquid flows into the housing 15 and engages the impeller 45, the liquid forces the blades 380 to rotate the shaft 50, and thus the magnets 340. The magnets 340 rotate and create a magnetic field which in turn causes the coil 345 to conduct electricity. The electricity is conducted via the conductive wire 263 from the coil 345 to the light emitting diodes 245 on the printed circuit board 250. Alternatively, the conductive wire 263 may extend from the nose cone 275 into the passageway 175 and through the housing 15 up into the epoxy filled cavity 260 to the printed circuit board 250.

The liquid powered illuminescent device 10 directs the liquid flow through a uniform diameter, linear cylindrical passageway 175 so that the liquid is not redirected or diverted so as to reduce the velocity or uniformity of the liquid. Also, the generator assembly 30 suspended within the passageway 175 is shaped so as to direct the flowing liquid around the generator assembly 30 with limited turbulence or diversion. Thus, the illuminescent device 10 limits the obstructions to the flow of the liquid so that the liquid flows faster and may be used to generate more power.

The illuminescent device 10 utilizes light emitting diodes 245, which require less electrical power than traditional lighting systems. Also, the light emitting diodes 245 are small and may be positioned around the nozzle 20 to avoid interference with the flowing liquid.

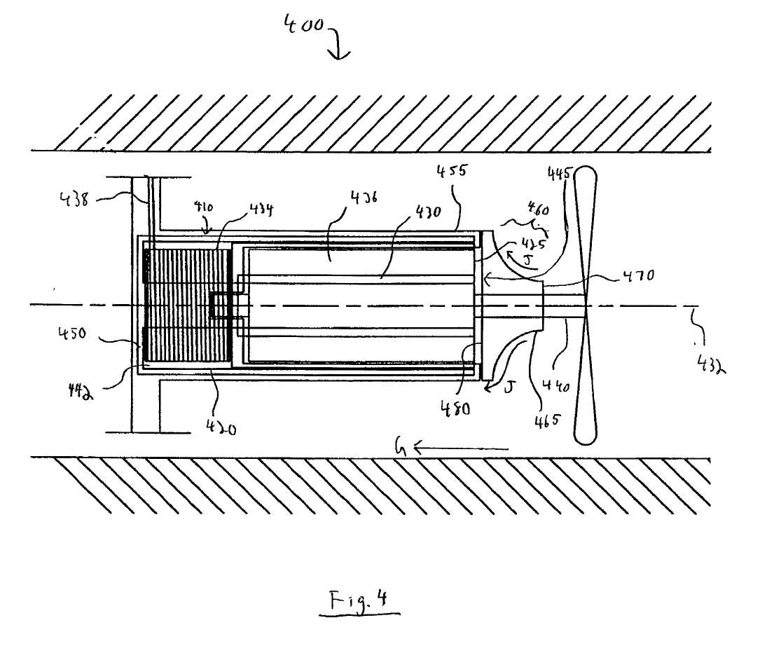

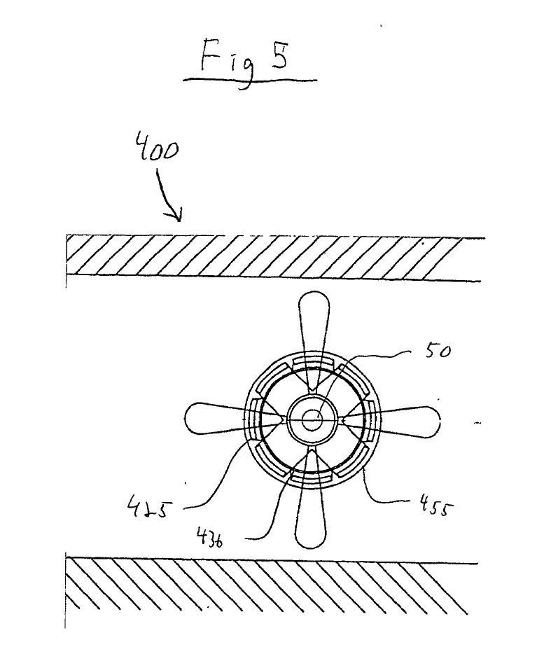

FIG. 4 illustrates a cutaway side view of a generator assembly 400 according to an alternative embodiment of the present invention. FIG. 5 illustrates an end view of the generator assembly 400. The generator assembly 400 is partially enclosed within a cylindrical steel cage 410. The cage 410 has a wall 420 including a series of prongs 425 separated by slits 430. The cage wall 420 includes an outer diameter, and the cage 410 is aligned along a longitudinal axis 432 enclosing a coil 434, magnets 436, and portions of a conductive wire 438 and a shaft 440 within a cavity 442. The cage 410 includes an open front end 445 that leads into the cavity 442 and a closed back end 450 located opposite to the front end 445. The slits 430 extend longitudinally from the open front end 445 to the back end 450.

The cage 410, the coil 434, and the section of the conductive wire 438 located within the cage 410 are over molded together so that the coil 434 and the conductive wire 438 are encapsulated within the cage 410 in a plastic seal 455 and the slits 430 are covered in the plastic seal 455 so as to close the cage 410 up to the open front end 445. The coil 434 and the magnets 436 are aligned end to end. The magnets 436 are arranged around the shaft 440 as shown in FIG. 6. The generator assembly 400 also includes a funnel-shaped cap 460 that retains the shaft 440. The cap 460 includes a curved wall 465 joining a front end 470 having a small diameter and a back end 480 having a large diameter generally equal to the outer diameter of the cage 410. The cap 460 is positioned on the shaft 440 with the back end 480 located proximate the open front end 445 of the cage 410. The curved wall 465 directs fluid flowing in the direction of arrow G around the cage 410 as indicated by arrows J with limited turbulence and flow reduction. However, the cap 460 may not sealably cover the end of the cage 410, in which case fluid enters the cavity 440 and surrounds the magnets 436, but does not contact the plastically encased coil 434.

In operation, the generator assembly 410 is similar to the generator assembly 30 of FIGS. 1 and 2 except that the magnets 436 rotate in liquid.

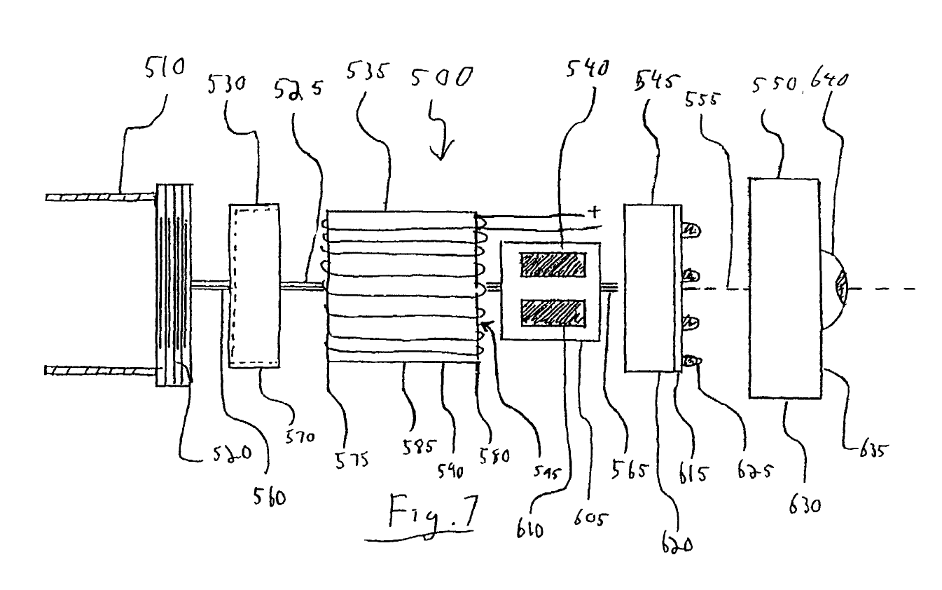

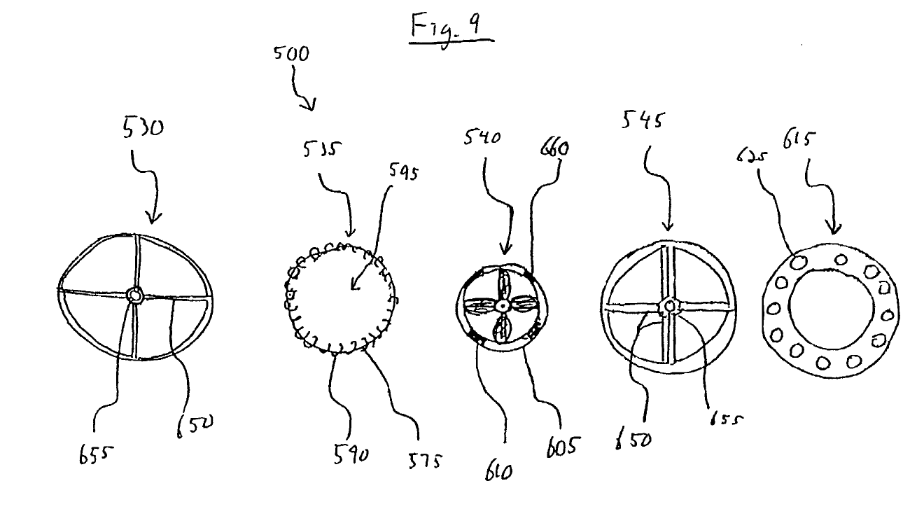

FIGS. 7 and 9 illustrate exploded side and end views, respectively, of a liquid powered illuminescent device 500 formed according to an alternative embodiment of the present invention. The illuminescent device 500 includes a shaft 525, a plastic rear holding ring 530, a plastic dipped winding ring 535, an impeller 540, a plastic front holding ring 545, and a plastic nozzle ring 550 that are all aligned along a longitudinal axis 555. The shaft 525 includes a first end 560 and a second end 565. The cylindrical rear holding ring 530 includes a wall 570, and the cylindrical front holding ring 545 includes a light ring 615 and a cylindrical wall 620. The rear and front holding rings 530 and 545 include cross bars 650 and shaft apertures 655. The shaft apertures 655 are concentric with the rear and front holding rings 530 and 545. The rear and front holding rings 530 and 545 rotatably support the first and second ends 560 and 565, respectively, of the shaft 525, but do not rotate with the shaft 525.

The winding ring 535 includes a first rim 575, a second rim 580, a cylindrical wall 585, and a coil 590 that wraps around the wall 585 along the rims 575 and 580. The coil 590 is wrapped around the first and second rims 575 and 580 with the coil 590 running inside and outside the winding ring 535. The winding ring 535 also includes a tubular interior passageway 595 with a uniform interior diameter. The winding ring 535 and the coil 590 have been over molded for protection from the liquid. The winding ring 535 does not rotate with the shaft 525. The impeller 540 includes a cylindrical ring 605, square magnets 610 connected to the ring 605, and blades 660. The blades 660 are angled to rotate the ring 605 around the shaft 525 when contacted by flowing liquid. The magnets 610 rotate with the impeller 540 around the shaft 525 to create a magnetic field.

The light ring 615 includes concentrically aligned and bulb-shaped light emitting diodes 625. The cylindrical nozzle ring 550 includes a wall 630, a front surface 635, and a nozzle 640. The wall 630 includes a threaded interior surface (not shown) that corresponds to threads 520 of a pool pipe 510. The front surface 635 includes light apertures (not shown) that correspond to the light emitting diodes 625.

Because the coil 590 is over molded along the wall 585 of the winding ring 535 and the magnets 610 are connected to the impeller 540, the magnets 610 and coil 590 do not need to be protected within a casing that may take up space within the interior passageway 595. Only the cross bars 650 of the holding rings 530 and 545, the shaft 525, the impeller 540, and portions of the coil 590 are positioned within the interior passageway 595, so the liquid flow is generally uninterrupted.

When the illuminescent device 500 is fully assembled, the rear holding ring 530 covers the first rim 575 of the winding ring 535 and the impeller 540 is suspended inside the wall 585 of the winding ring 535 along the shaft 525. The front holding ring 545 covers the second rim 580 of the winding ring 535. The nozzle ring 550 encloses and is connected to the front holding ring 545 so that the light emitting diodes 625 protrude out the front surface 635 of the nozzle ring 550. The rear holding ring 530, winding ring 535, impeller 540, and the front holding ring 545 are all positioned within the pool pipe 510. The nozzle ring 550 encloses, and threadably communicates with, the threads 520 of the pool pipe 510 to retain the illuminescent device 500 within the pool pipe 510.

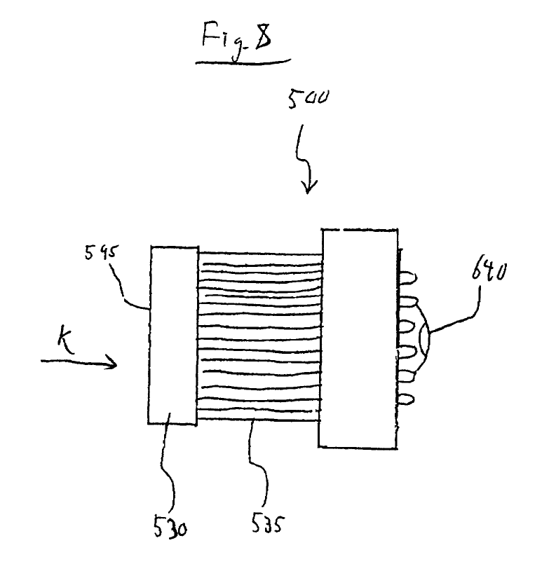

FIG. 8 illustrates an assembled side view of the illuminescent device 500 of FIGS. 7 and 9. The illuminescent device 500 is fully assembled so that the illuminescent device 500 may be properly inserted into the pool pipe of FIG. 7. During operation, liquid flows in the direction of arrow K, through the rear holding ring 530 into the linear interior passageway 595 of the winding ring 535 and out the nozzle 640. Because the interior passageway 595 is linear and has a uniform interior diameter, the liquid experiences little direction change or turbulence.

Optionally, electro luminescent films, and other low power light emitting devices may be substituted for the light emitting diodes 245 within the light ring 25. Also, the light emitting diodes 245 or other light emitting devices may be arranged on the light ring 25 in any number of different positions and patterns. For example, the light emitting diodes 245 may be aligned circumferentially around the exterior wall 185 between or in place of the grip scallops 240, or the light emitting diodes 245 may extend from the top wall 180 or exterior wall 185 of the light ring 25 at different angles. Optionally, the light “ring” 25 and/or the housing 15 may be square, triangular, octagonal, or any number of other shapes.

Optionally, the coil 345 may be located about the perimeter of the magnets 340 with the magnets 340 rotating with the coil 345. Alternatively, the coil 345 may be located within the magnets 340, and the coil 345 rotated within the magnets 340.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A liquid powered illuminescent device, comprising:
a housing configured to be connected to a liquid supply, said housing having an inlet port and a discharge port arranged at opposite ends of said housing and having a linear passageway extending along a straight path entirely through said housing from said inlet port to said discharge port, said linear passageway being configured to convey liquid from said inlet port to said discharge port;
a power generator located in said linear passageway and configured to convert energy from liquid flowing through said linear passageway into electric power; and
a light source mounted on said housing and driven by said power generator.

2. The device of claim 1, wherein said inlet and discharge ports and said linear passageway are centered about a common axis, said linear passageway having a uniform constant diameter along an entire length thereof.

3. The device of claim 1, wherein said linear passageway is tubularly shaped and centered about a linear longitudinal axis extending along a center of said housing.

4. The device of claim 1, further comprising a light ring mounted to one end of said housing and surrounding one of said inlet and discharge ports, said light ring constituting said light source.

5. The device of claim 1, wherein said light source includes at least one of a light emitting diode and an electroluminescent film.

6. The device of claim 1, wherein said light source includes a plurality of light emitting diodes arranged in a concentric circle about one of said inlet and discharge ports.

7. The device of claim 1, further comprising:
a ring shaped bracket mounted to one end of said housing, said ring shaped bracket defining a circumferential chamber; and
a printed circuit board mounted in said circumferential chamber and connected to said light source, said printed circuit board being arranged concentric with said linear passageway.

8. The device of claim 1, wherein said light source includes light emitting diodes arranged in a circle concentric with said linear passageway.

9. The device of claim 1, further comprising a nozzle pivotally attached to one of said inlet and discharge ports.

10. The device of claim 1, further comprising an impeller being configured to be rotatably driven by liquid flowing through said linear passageway.

11. The device of claim 1, further comprising fins mounted to said housing and suspending said power generator in a center of said linear passageway.

12. The device of claim 1, wherein said power generator includes magnets and a coil centered about a fluid axis of said linear passageway, said magnets being adapted to be rotated about said fluid axis in response to fluid flow through said linear passageway.

13. The device of claim 1, wherein said linear passageway extends through an interior of said generator.

14. The device of claim 1, wherein said power generator including magnets and a coil arranged concentric with one another, said linear passageway extending through an interior of at least one of said coil and magnets.

15. The device of claim 1, wherein said power generator includes magnets and a coil aligned end to end, one of said magnets and coil being rotatable, said power generator further including angled tabs having one end extending along an end of said coil and having an opposite end extending along a side of at least one of said coil and said magnets, said angled tabs electromagnetically coupling said magnets to said coil.

16. A self powered light comprising:
a housing configured to be connected to a liquid supply, said housing having an inlet port and a discharge port arranged at opposite ends thereof and having a passageway interconnecting said inlet and discharge ports, said housing being aligned along a longitudinal axis;
a power generator located in said passageway and configured to convert liquid flowing through said passageway into electric power; and
a plurality of light emitting diodes arranged in a ring concentrically about one of said inlet and discharge ports.

17. The self powered light of claim 16, further comprising a circular bracket mounted to one end of said housing, said circular bracket defining a chamber extending about a circumference of, and arranged concentric with one of said inlet and discharge ports, and a printed circuit board located in said chamber and operatively connected to said light emitting diodes.

18. The self powered light of claim 16, further comprising a printed circuit board hermetically sealed within said housing, said printed circuit board being electrically connected to said light emitted diodes.

19. The self powered light of claim 16, further comprising a ring shaped printed circuit board hermetically sealed within said housing, said printed circuit board having said light emitted diodes mounted thereto and electrically communicating with said power generator.

20. The self powered light of claim 16, wherein said passageway is linear to define a straight path extending entirely through said housing from said inlet port to said discharge port, said passageway being configured to convey liquid from said inlet to said discharge port.

21. The self powered light of claim 16, wherein said inlet and discharge ports and said passageway are centered about a common linear axis extending entirely through said housing.

22. The self powered light of claim 16, wherein said passageway is tubularly shaped with a uniform diameter centered about a longitudinal axis extending entirely through said housing.

23. A hydroelectric generator for driving low power electrical components, comprising:
a housing configured to be colnected to a water supply, said housing having an inlet port and a discharge port arranged at opposite ends thereof, said housing having a linear passageway extending along a straight path entirely through said housing from said inlet port to said discharge port, said linear passageway being configured to convey water from said inlet port to said discharge port;
a power generator mounted in said linear passageway and configured to convert energy from water flowing through said linear passageway into electric power, said generator including magnets and a coil centered about an axis of said linear passageway, at least one of said coil and magnets being adapted to be rotated relative to said housing and about said axis in response to a water flow through said linear passageway; and
an electric output from said power generator delivering electrical power to a low power electrical component operatively connected to said power generator.

24. The hydroelectric generator of claim 23, wherein said electrical component includes light emitting diodes arranged in a circle concentric with said linear passageway.

25. The hydroelectric generator of claim 23, further comprising a light ring mounted to one end of said housing and surrounding one of said inlet and discharge ports, said light ring including a plurality of light emitted diodes powered by said power generator.

26. The hydroelectric generator of claim 23, further comprising a plurality of light emitting diodes arranged in a ring about one of said inlet and discharge ports.

27. The hydroelectric generator of claim 23, further comprising a ring shaped printed circuit board mounted in said housing and arranged concentrically with said linear passageway, said printed circuit board being configured to support electrical components driven by said power generator.

28. The hydroelectric generator of claim 23, wherein said linear passageway extends through an interior of said magnets and coil.

29. The hydroelectric generator of claim 23, wherein said magnets and coil are aligned end to end, one of said magnets and coil being rotatable, said power generator further including tabs extending along an end of said coil and along sides of at least one of said coil and magnets, said tabs electromagnetically coupling said magnets to said coil.

30. The hydroelectric generator of claim 23, wherein said linear passageway extends about a perimeter of said power generator.
